(19) United States
(12) Patent Application Publication
(10) Pub. No.: US 2016/0253779 A1
(43) Pub. Date: Sep. 1, 2016

(54) IMAGE PROCESSING APPARATUS AND METHOD

(71) Applicant: Samsung Electronics Co., Ltd., Gyeonggi-do (KR)

(72) Inventors: Hyun-Hee PARK, Seoul (KR); Sung-Oh Kim, Gyeonggi-do (KR); Kwang-Young Kim, Gyeonggi-do (KR); Yong-Man Lee, Gyeonggi-do (KR)

(73) Assignee: Samsung Electronics Co., Ltd.

(21) Appl. No.: 15/056,653

(22) Filed: Feb. 29, 2016

(30) Foreign Application Priority Data
Feb. 27, 2015 (KR) 10-2015-0028651

(51) Int. Cl. G06T 3/40; G06T 5/20; G06T 5/00

(52) U.S. Cl. CPC G06T 3/4007; G06T 5/002; G06T 5/20

(57) ABSTRACT

An electronic device and a method for processing a plurality of images are provided. The electronic device includes a memory for storing an image, and an image processor configured to obtain additional information generated based on at least one of a portion of edge information and a portion of scale information related to an input image, and to generate an output image corresponding to at least a portion of the input image, based on the obtained additional information.

### PRIORITY

This application claims priority under 35 U.S.C. §119(a) to Korean Patent Application Serial No. 10-2015-0028651, which was filed in the Korean Intellectual Property Office on Feb. 27, 2015, the entire disclosure of which is incorporated herein by reference.

### BACKGROUND

1. Field of the Disclosure

The present disclosure relates generally to an apparatus and method for processing images based on additional information.

2. Description of the Related Art

An electronic device often uses a lot of resources to process high-definition or large-volume images. For example, in order to compute a large amount of data related to conversion or correction of the high-definition images, the electronic device may use a relatively large amount of memory or processing resources. Further, in order to transmit large-volume images to other devices, the electronic device may use a relatively large amount of networking resources to increase the data throughput or the data rate.

The electronic device may convert the format of images in order to process high-definition images and transmit large-volume images. For example, the electronic device may convert a red-green-blue (RGB) image format including a red component, a green component, and a blue component of an image based on an RGB color model, into an YCbCr image format including a luminance component, a blue difference chroma component and a red difference chroma component of an image, to process the image. For example, the electronic device may adjust (e.g., increase) the brightness of an image by adjusting (e.g., increasing) the luminance component included in the YCbCr image format of the image.

However, when the electronic device converts the format of an image, loss of image data may occur. For example, when the electronic device generates a blue difference chroma component in a YCbCr image format by sampling some blue components of an RGB image while converting the RGB image into the YCbCr image, unsampled blue components may be lost. Consequently, if the electronic device restores the blue component from the blue difference chroma component, the unsampled blue components may not be restored.

Further, when the electronic device processes images over several operations, inefficiencies may occur. For example, because the electronic device may repeatedly generate certain information in a duplicate manner while processing complex images, data computation or data throughput of the electronic device may increase. The electronic device may use the brightness information of an image in both a first image processing operation (e.g., an auto exposure operation) and a second image processing operation (e.g., a color enhancement operation), proceeding in sequence among a plurality of image processing operations. In this case, the electronic device may inefficiently extract brightness information from an image, use the brightness information, delete the brightness information in the first image processing operation (e.g., the auto exposure operation), and then re-extract the same brightness information from the image in the second image processing operation (e.g., the color enhancement operation).

### SUMMARY

The present disclosure is designed to address at least the problems and/or disadvantages described above and to provide at least the advantages described below.

An aspect of the present disclosure is to provide an image processing apparatus and method that restore an image, after storing the image in edge information and scale information in a division manner.

Another aspect of the present disclosure is to provide an image processing apparatus and method that use information from a first image processing operation, in a second image processing operation.

In accordance with an aspect of the present disclosure, an electronic device is provided that includes a memory configured to store an image; and an image processor configured to obtain additional information generated based on at least one of a portion of edge information and a portion of scale information related to an input image, and to generate an output image corresponding to at least a portion of the input image, based on the obtained additional information.

In accordance with another aspect of the present disclosure, an electronic device is provided that includes a memory configured to store an image; and an image processor configured to generate edge information of the image, based on filtering of the image, to generate scale information of the image, based on scaling of the image, and to generate additional information related to the image, based on at least one of a portion of the edge information and a portion of the scale information.

In accordance with another aspect of the present disclosure, a method is provided for processing an image by an electronic device. The method includes obtaining additional information that is generated based on at least one of a portion of edge information and a portion of scale information related to an input image; and generating an output image corresponding to at least a portion of the input image based on the obtained additional information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 illustrates an electronic device according to an embodiment of the present disclosure;

FIG. 3 illustrates a program module according to an embodiment of the present disclosure;

FIG. 4 illustrates a method of generating image information by an electronic device according to an embodiment of the present disclosure;

FIG. 5 illustrates a method of generating an output image using image information by an electronic device according to an embodiment of the present disclosure;

FIG. 6 illustrates a method of restoring an image without visual loss by an electronic device according to an embodiment of the present disclosure;

FIG. 7 illustrates a method of restoring an image without data loss by an electronic device according to an embodiment of the present disclosure;

FIG. 8 illustrates a method of updating additional information by an electronic device in a network environment according to an embodiment of the present disclosure; and

FIG. 9 is a flowchart illustrating a method for processing an image by an electronic device according to an embodiment of the present disclosure.

Throughout the drawings, like reference numerals will be understood to refer to like parts, components, and structures.

### DETAILED DESCRIPTION

Hereinafter, various embodiments of the present disclosure will be described with reference to the accompanying drawings. However, the present disclosure is not limited to these particular embodiments, and it should be construed as including various modifications, equivalents, and/or alternatives thereof.

Terms defined in the present disclosure are used to describe specific embodiments and are not intended to limit the scope of other embodiments.

The singular form of a term may include a plurality of forms, unless explicitly defined as such.

All terms, including technical and scientific terms, have the same meanings as generally understood by a person of ordinary skill in the art. Further, terms defined in general dictionaries have the same or similar meanings to those of related technologies and should not be analyzed as having ideal or excessively formal meanings unless explicitly defined as such. Further, the terms defined herein should not be analyzed to exclude other embodiments.

Herein, expressions such as “having,” “may have,” “comprising,” and “may comprise” indicate the existence of a corresponding characteristic or feature (e.g., a numerical value, function, operation, or component), but do not exclude the existence of additional characteristics.

Expressions such as “A or B,” “at least one of A or/and B,” and “one or more of A or/and B” may include all possible combinations of the listed items. For example, “A or B,” “at least one of A and B,” and “one or more of A or B” may indicate (1) at least one A, (2) at least one B, or (3) at least one A and at least one B.

Expressions such as “first,” “second,” “primarily,” and “secondary” may represent various elements, regardless of order and/or importance, and do not limit corresponding elements. For example, the expressions may be used to distinguish one element from another element, e.g., a first user device and a second user device may represent different user devices. Accordingly, a first element may be referred to as a second element without deviating from the scope of the present disclosure, and similarly, a second element may be referred to as a first element.

When an element (e.g., a first element) is “operatively or communicatively coupled” to or “connected” to another element (e.g., a second element), the first element may be directly connected to the second element, or another element (e.g., a third element) may exist therebetween. However, when the first element is “directly connected” or “directly coupled” to the second element, there is no intermediate element therebetween.

The expression “configured to” may be used interchangeably with “suitable for,” “having the capacity to,” “designed to,” “adapted to,” “made to,” “capable of,” etc., according to context. The term “configured to” does not always mean only “specifically designed to” by hardware.

The expression “an apparatus configured to” may mean that the apparatus “can” operate together with another apparatus or component. For example, “a processor configured to perform A, B, and C” may identify a generic-purpose processor, such as a central processing unit (CPU) or an application processor, which can perform a corresponding operation by executing at least one software program stored at an exclusive processor, such as an embedded processor, for performing a corresponding operation or at a memory device.

The term “module” may refer to a unit that includes one or a combination of hardware, software, or firmware. The term “module” may be interchangeably used with terms such as unit, logic, logical block, component, and/or circuit. The term “module” may be a minimum unit of an integrally constructed part, or a part thereof. The term “module” may be the minimum unit for performing one or more functions, or a part thereof. A module may be implemented mechanically or electronically. For example, a module may include at least one of an application-specific integrated circuit (ASIC) chip, field-programmable gate arrays (FPGAs), or a programmable-logic device, which are known or will be developed in the future, and which perform certain operations.

Herein, an electronic device may be a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device, such as an accessory-type wearable device (e.g., a watch, a ring, a bracelet, an anklet, a necklace, glasses, contact lens or a head mounted device (HMD), a textile/clothing integrated wearable device (e.g., electronic clothing), body-mounted wearable device (e.g., skin pad or tattoo), or a body implantable wearable device (e.g., implantable circuit)).

The electronic device may also be a smart home appliance, such as a television (TV), a digital video disk (DVD) player, an audio player, a refrigerator, an air conditioner, a cleaner, an oven, a microwave oven, a washer, an air purifier, a set-top box, a home automation control panel, a security control panel, a TV box (e.g., a Samsung HomeSync®, an Apple TV®, or a Google TV®), a game console (e.g., Xbox® or PlayStation®), an electronic dictionary, an electronic key, a camcorder, or a digital photo frame.

The electronic device may be a medical device (e.g., a portable medical meter (e.g., a blood glucose meter, a heart rate meter, a blood pressure meter, a temperature meter, etc.), a magnetic resonance angiography (MRA) device, a magnetic resonance imaging (MRI) device, a computed tomography (CT) device, a medical camcorder, an ultrasonic device, etc.), a navigation device, a global positioning system (GPS) receiver, an event data recorder (EDR), a flight data recorder (FDR), an automotive infotainment device, a marine electronic device (e.g., a marine navigation device, a gyro compass, etc.), avionics equipment, a security device, a car head unit, an industrial or household robot, an automatic teller machine (ATM), a point of sales (POS) device, or an Internet of things (IoT) device (e.g., an electric bulb, various sensors, an electricity or gas meter, a sprinkler device, a fire alarm, a thermostat, a streetlamp, a toaster, fitness equipment, a hot water tank, a heater, a boiler, etc.).

The electronic device may include at least one of a part of the furniture or building/structure, an electronic board, an electronic signature receiving device, a projector, or various meters (e.g., meters for water, electricity, gas or radio waves).

The electronic device may also be a flexible electronic device.

The electronic device may also be a combination of at least two of the above-described devices.

Notably, an electronic device according to an embodiment of the present disclosure is not be limited to the above-described examples, and may include a new electronic device provided by the development of new technology.

Herein, the term “user” may refer to a person who uses the electronic device, or a device (e.g., an artificial intelligence device) that uses the electronic device.

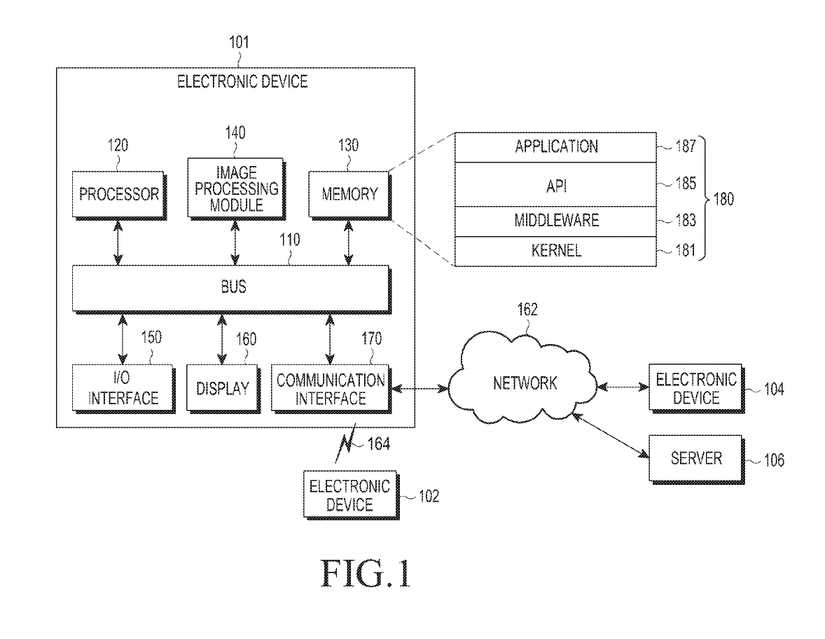

FIG. 1 illustrates a network environment including an electronic device according to an embodiment of the present disclosure.

Referring to FIG. 1, the electronic device 101 includes a bus 110, a processor 120, a memory 130, an image processing module 140, an input/output (I/O) interface 150, a display 160, and a communication interface 170. Alternatively, the electronic device 101 may omit at least one of the components, or may include additional components.

The bus 110 may include a circuit that connects the components 120 to 170, and transfers a communication (e.g., a control message and/or data) between the components 120 to 170.

The processor 120 may include a CPU, an application processor (AP), and/or a communication processor (CP). The processor 120 may execute control and/or communication-related operations or data processing for at least one other component of the electronic device 101.

The memory 130 may include a volatile and/or non-volatile memory. The memory 130 may store a command or data related to at least one other component of the electronic device 101. The memory 130 stores software and/or a program 180. The program 180 includes a kernel 181, middleware 183, an application programming interface (API) 185, and applications 187. At least one of the kernel 181, the middleware 183 or the API 185 may be referred to as an operating system (OS).

The kernel 181 may control or manage system resources (e.g., the bus 110, the processor 120, the memory 130, etc.) that are used to execute the operation or function implemented in other programs (e.g., the middleware 183, the API 185, the applications 187, etc.). Further, the kernel 181 may provide an interface through which the middleware 183, the API 185, and/or the applications 187 can control or manage the system resources by accessing the individual components of the electronic device 101.

The middleware 183 may perform an intermediary role for the API 185 or the applications 187 to exchange data with the kernel 181 by communicating with the kernel 181. Further, the middleware 183 may process one or more work requests received from the applications 187 according to their priority. For example, the middleware 183 may give priority for using the system resources of the electronic device 101 (e.g., the bus 110, the processor 120, the memory 130, etc.), to at least one of the applications 187. For example, the middleware 183 may process the one or more work requests according to the priority given to at least one of the applications 187, thereby performing scheduling or load balancing for the one or more work requests.

The API 185 is an interface through which the applications 187 control functions provided in the kernel 181 or the middleware 183, and may include at least one interface or function (e.g., a command) for file control, window control, image processing, and/or character control.

The I/O interface 150 may serve as an interface for transferring a command or data received from the user or other external device to the other components of the electronic device 101. Further, the I/O interface 150 may output a command or data received from the other components of the electronic device 101, to the user or other external devices.

The display 160 may include a liquid crystal display (LCD) display, a light emitting diode (LED) display, an organic light emitting diode (OLED) display, a micro-electromechanical systems (MEMS) display, or an electronic paper display. The display 160 may display a variety of content (e.g., texts, images, videos, icons, symbols, etc.). The display 160 may include a touch screen that receives touch, gesture, proximity and/or hovering inputs made by an electronic pen or a part of the user's body.

The communication interface 170 may establish communication between the electronic device 101 and a first external electronic device 102, a second external electronic device 104, or a server 106. For example, the communication interface 170 may communicate with the second external electronic device 104 or the server 106 by being connected to a network 162 through wireless communication or wired communication.

The wireless communication may include long term evolution (LTE), long term evolution-advanced (LTE-A), code division multiple access (CDMA), wideband code division multiple access (WCDMA), universal mobile telecommunication system (UMTS), wireless broadband (WiBro) or global system for mobile communication (GSM), as a cellular communication protocol. Further, the wireless communication may include short range communication 164, e.g., wireless fidelity (WiFi), Bluetooth (BT), near field communication (NFC), or global positioning system (GPS).

The wired communication may include universal serial bus (USB), high definition multimedia interface (HDMI), recommended standard 232 (RS-232), or plain old telephone service (POTS).

The network 162 may include a telecommunications network, for example, a computer network (e.g., a local area network (LAN) or a wide area network (WAN)), the Internet, or the telephone network.

The image processing module 140 may obtain additional information (e.g., binary data of edge information or scale information, high-frequency component information, color information, brightness information, pattern information, motion information, and/or a black level value) that is generated based edge information (e.g., high-frequency component information) and scale information (e.g., a down-scaled image) related to an input image, and may generate an output image corresponding to the input image, based on the obtained additional information. For example, the image processing module 140 may up-scale the down-scaled input image included in the scale information, and generate the output image using the up-scaled input image and the edge information.

Although FIG. 1 illustrates the image processing module 140 as a different component than the processor 120 and the memory 130, the present disclosure is not be limited thereto. For example, the image processing module 140 may be integrated with the processor 120, and/or may be stored in the memory 130 in the form of software to be executed in the processor 120. Further, the image processing module 140 may be distributed in the processor 120 and the memory 130.

Each of the first and second external electronic devices 102 and 104 may be the same as or different type of device as the electronic device 101.

The server 106 may include a group of one or more servers.

All or some of the operations executed in the electronic device 101 may be executed in one or multiple other electronic devices (e.g., the electronic devices 102 and 104 or the server 106).

If the electronic device 101 should perform a certain function or service automatically or upon request, the electronic device 101 may request at least some of the functions related thereto from the electronic devices 102 and 104 or the server 106, instead of or in addition to executing the function or service. The electronic devices 102 and 104 or the server 106 may execute the requested function or additional function, and deliver the results to the electronic device 101. The electronic device 101 may then process the received results intact or additionally, thereby providing the requested function or service. For example, cloud computing, distributed computing, or client-server computing technology may be used.

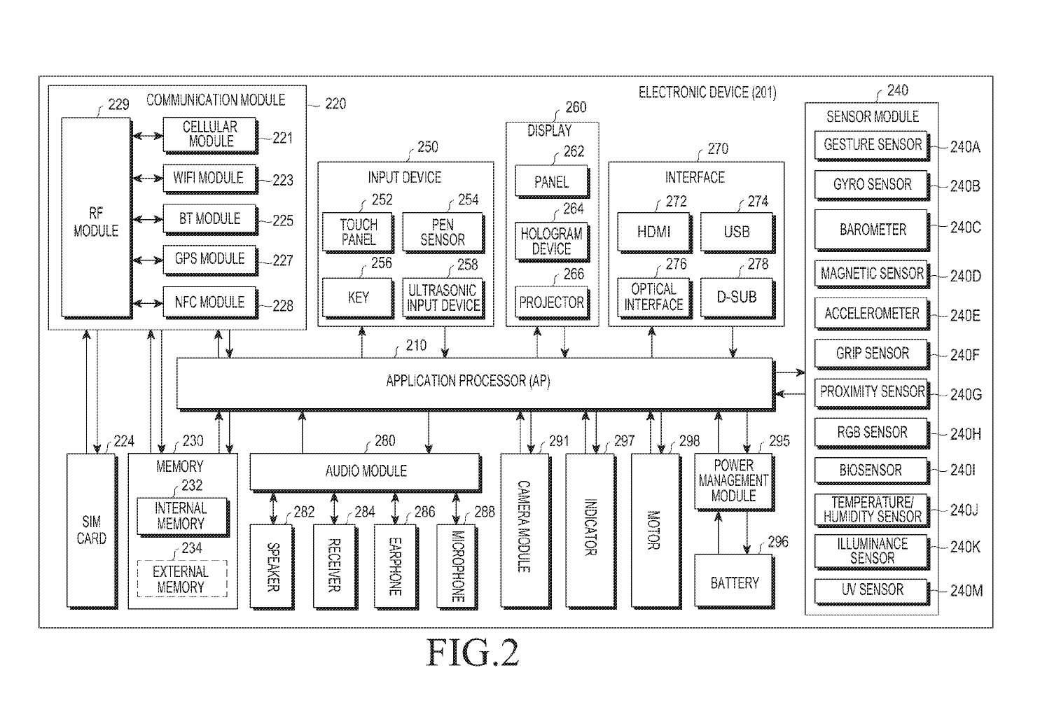

FIG. 2 illustrates an electronic device according to an embodiment of the present disclosure.

Referring to FIG. 2, the electronic device 201 includes an application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by running the OS or an application, and may process and calculate a variety of data. The processor 210 may be implemented as a system on chip (SoC). The processor 210 may further include a graphic processing unit (GPU) and/or an image signal processor.

Alternatively, the processor 210 may also include at least some (e.g., a cellular module 221) of the other components illustrated in FIG. 2.

The processor 210 may load, on a volatile memory, a command or data received from at least one of other components (e.g., a non-volatile memory) and process the loaded data, and may store a variety of data in a non-volatile memory.

The communication module 220 includes the cellular module 221, a WiFi module 223, a BT module 225, a GPS module 227, an NFC module 228, and a radio frequency (RF) module 229.

The cellular module 221 may provide a voice call service, a video call service, a messaging service or an Internet service over a communication network. The cellular module 221 may perform identification and authentication of the electronic device 201 within the communication network using the subscriber identification module 224 (e.g., a SIM card). The cellular module 221 may perform some of the functions that can be provided by the processor 210. Alternatively, the cellular module 221 may include a CP.

Each of the WiFi module 223, the BT module 225, the GPS module 227, or the NFC module 228 may include a processor for processing the data transmitted or received through the corresponding module. At least some (e.g., two or more) of the cellular module 221, WiFi module 223, the BT module 225, the GPS module 227 or the NFC module 228 may be included in one integrated chip (IC) or IC package.

The RF module 229 may transmit and receive communication signals (e.g., RF signals). The RF module 229 may include a transceiver, a power amplifier module (PAM), a frequency filter, a low noise amplifier (LNA), and/or an antenna. At least one of the cellular module 221, the WiFi module 223, the BT module 225, the GPS module 227, or the NFC module 228 may transmit and receive RF signals through a separate RF module.

The SIM card 224 may be removable or embedded. The SIM card 224 may include unique identification information (e.g., integrated circuit card identifier (ICCID)) or subscriber information (e.g., international mobile subscriber identity (IMSI)).

The memory 230 includes an internal memory 232 and an external memory 234. The internal memory 232 may include a volatile memory (e.g., dynamic RAM (DRAM), static RAM (SRAM), synchronous dynamic RAM (SDRAM), etc.) or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., a NAND flash, a NOR flash or the like), hard drive, or solid state drive (SSD)).

The external memory 234 may further include a flash drive, a compact flash (CF), secure digital (SD), micro secure digital (Micro-SD), mini secure digital (Mini-SD), extreme digital (xD), a multi-media card (MMC), a memory stick, etc. The external memory 234 may be functionally and/or physically connected to the electronic device 201 through various interfaces.

The sensor module 240 may measure the physical quantity or detect the operating status of the electronic device 201, and convert the measured or detected information into an electrical signal. The sensor module 240 includes a gesture sensor 240A, a gyro sensor 240B, a barometer 240C, a magnetic sensor 240D, an accelerometer 240E, a grip sensor 240F, a proximity sensor 240G, an RGB sensor 240H, a biosensor 240I, a temperature/humidity sensor 240J, an illuminance sensor 240K, and a ultra violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor and/or a fingerprint sensor.

The sensor module 240 may further include a control circuit for controlling at least one or more sensors belonging thereto. The electronic device 201 may further include a processor configured to control the sensor module 240, independently of or as a part of the processor 210, in order to control the sensor module 240 while the processor 210 is in a sleep state.

The input device 250 includes a touch panel 252, a (digital) pen sensor 254, a key 256, and an ultrasonic input device 258. The touch panel 252 may use at least one of a capacitive, resistive, infrared or ultrasonic scheme. The touch panel 252 may further include a control circuit, and/or a tactile layer that provides a tactile or haptic feedback to the user.

The (digital) pen sensor 254 may be a part of the touch panel 252, or may include a separate recognition sheet.

The key 256 may include a physical button, an optical key or a keypad.

The ultrasonic input device 258 may detect ultrasonic waves generated in an input tool using a microphone 288, in order to identify the data corresponding to the detected ultrasonic waves.

The display 260 includes a panel 262, a hologram device 264, and a projector 266. The panel 262 may be implemented to be flexible, transparent, or wearable. The panel 262 and the touch panel 252 may be implemented as one module.

The hologram device 264 may show stereoscopic images in the air using the interference of the light.

The projector 266 may display images by projecting the light on the screen. The screen may be disposed on the inside or outside of the electronic device 201.

The display 260 may further include a control circuit for controlling the panel 262, the hologram device 264, and/or the projector 266.

The interface 270 includes an HDMI 272, a USB 274, an optical interface 276, and D-subminiature (D-sub) 278. Additionally or alternatively, the interface 270 may include a mobile high-definition link (MHL) interface, a secure digital (SD) card/multi-media card (MMC) interface, and/or an infrared data association (IrDA) interface.

The audio module 280 may convert the sounds and the electrical signals bi-directionally. The audio module 280 may process the sound information that is received or output through a speaker 282, a receiver 284, an earphone 286, and/or the microphone 288.

The camera module 291 captures still images and videos. The camera module 291 may include one or more image sensors (e.g., a front image sensor or a rear image sensor), a lens, an image signal processor (ISP), or a flash (e.g., an LED or xenon lamp).

The power management module 295 may manage the power of the electronic device 201. The power management module 295 may include a power management integrated circuit (PMIC), a charger integrated circuit (IC), or a battery gauge. The PMIC may have the wired and/or wireless charging schemes.

The wireless charging scheme may include a magnetic resonance scheme, a magnetic induction scheme, or an electromagnetic scheme, and the power management module 295 may further include additional circuits (e.g., a coil loop, a resonant circuit, a rectifier, etc.) for wireless charging.

The battery gauge may measure the remaining capacity, charging voltage, charging current, and/or temperature of the battery 296.

The battery 296 may include a rechargeable battery and/or a solar battery.

The indicator 297 may indicate a status (e.g., a boot status, a message status, a charging status, etc.) of the electronic device 201 or a part thereof (e.g. the processor 210).

The motor 298 may convert an electrical signal into mechanical vibrations, thereby generating a vibration or haptic effect.

Alternatively, the electronic device 201 may include a processing device (e.g., a GPU) for mobile TV support. The processing device for mobile TV support may process the media data based on a standard, such as digital multimedia broadcasting (DMB), digital video broadcasting (DVB), or MediaFLO®.

Each of the components illustrated in FIG. 2 may be configured with one or more components, the names of which may vary depending on the type of the electronic device. Further, the electronic device may include at least one of the components described herein, some of which may be omitted, or may further include additional other components. Further, some of the components of the electronic device may be configured as one entity by being combined, thereby performing the previous functions of the components in the same manner.

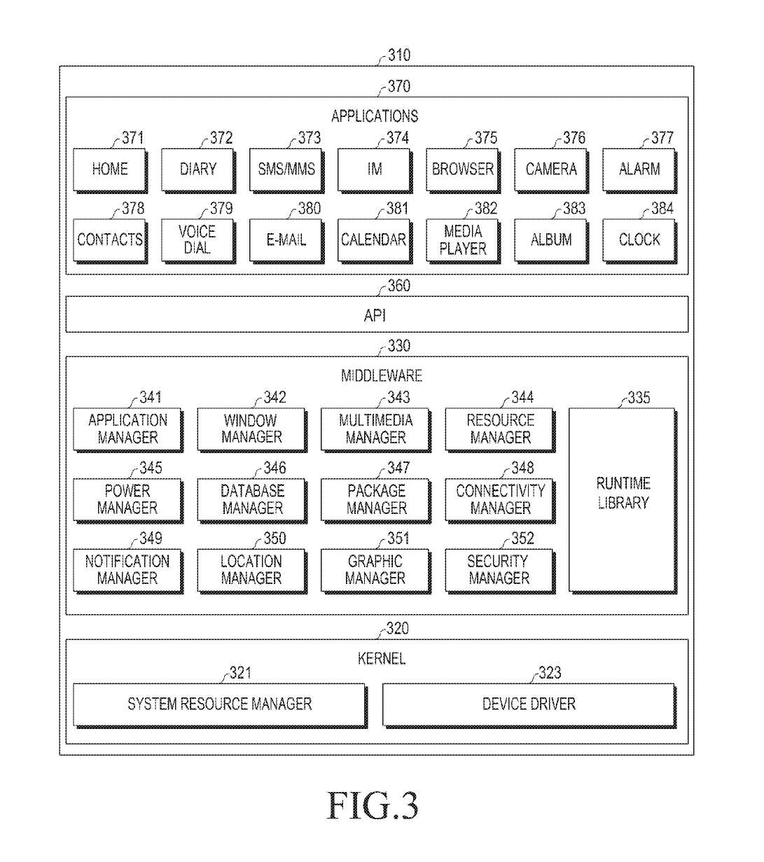

FIG. 3 illustrates a program module according to an embodiment of the present disclosure.

Referring to FIG. 3, a program module 310 may include an OS for controlling the resources related to the electronic device, and/or a variety of applications that run on the OS. For example, the OS may be Android®, iOS®, Windows®, Symbian®, Tizen®, Bala®, etc.

The program module 310 includes a kernel 320, middleware 330, an API 360, and applications 370. At least a part of the program module 310 may be preloaded on the electronic device, or downloaded from external electronic devices.

The kernel 320 includes a system resource manager 321 and a device driver 323. The system resource manager 321 may control, allocate, or recover the system resources. The system resource manager 321 may include a process manager, a memory manager, a file system manager, etc. The device driver 323 may include a display driver, a camera driver, a Bluetooth driver, a shared memory driver, a USB driver, a keypad driver, a WiFi driver, an audio driver, and/or an inter-process communication (IPC) driver.

The middleware 330 may provide a function that is used in common by the applications 370, or may provide various functions to the applications 370 through the API 360, such that the applications 370 may efficiently use the limited system resources within the electronic device. The middleware 330 includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses to add a new function through a programming language while one of the applications 370 is run. The runtime library 335 may perform an I/O management function, a memory management function, an arithmetic function, etc.

The application manager 341 may manage the life cycle of at least one of the applications 370.

The window manager 342 may manage graphic user interface (GUI) resources that are used on the screen.

The multimedia manager 343 may determine the format for playback of various media files, and encode or decode the media files using a codec for the format.

The resource manager 344 may manage resources such as a source code, a memory or a storage space for any one of the applications 370.

The power manager 345 may manage the battery or power by operating with the basic input/output system (BIOS), and provide power information required for an operation of the electronic device.

The database manager 346 may create, search, or update the database that is to be used by at least one of the applications 370.

The package manager 347 may manage installation or update of the applications 370 that are distributed in the form of a package file.

The connectivity manager 348 may manage wireless connection such as WiFi or Bluetooth.

The notification manager 349 may indicate or notify events such as message arrival, appointments, and proximity to a user.

The location manager 350 may manage the location information of the electronic device.

The graphic manager 351 may manage the graphic effect to be provided to the user, or the user interface related thereto.

The security manager 352 may provide various security functions for the system security or user authentication.

If the electronic device includes a phone function, the middleware 330 may further include a telephony manager for managing the voice or video call function of the electronic device.

The middleware 330 may include a middleware module that forms a combination of various functions of the above-described components. The middleware 330 may provide a module specialized for the type of the operating system in order to provide a differentiated function. Further, the middleware 330 may dynamically remove some of the existing components, or add new components.

The API 360 is a set of API programming functions, and may be provided in a different configuration depending on the operating system. For example, for Android® or iOS®, the API 360 may provide one API set per platform, and for Tizen®, the API 360 may provide two or more API sets per platform.

The applications 370 include a home application 371, a diary application 372, a short message service/multimedia messaging service (SMS/MMS) application 373, an instant message (IM) application 374, a browser application 375, a camera application 376, an alarm application 377, a contacts application 378, a voice dial application 379, an E-mail application 380, a calendar application 381, a media player application 382, an album application 383, and a clock application 384. Alternatively or additionally, the applications 370 may include a healthcare application (e.g., an application for measuring an amount of exercise, a blood glucose level, etc.), or an environmental information an application (e.g., an application for providing information about atmospheric pressure, humidity, temperature, etc.).

The applications 370 may also include an information exchange application that supports information exchange between the electronic device and external electronic devices. The information exchange application may include a notification relay application for delivering specific information to the external electronic devices, or a device management application for managing the external electronic devices.

For example, the notification relay application may deliver notification information generated in other applications (e.g., the SMS/MMS application 373, the E-mail application 380, the healthcare application, the environmental information application, etc.) of the electronic device, to the external electronic devices. Further, the notification relay application may receive notification information from an external electronic device, and provide the received notification information to the user.

The device management application may manage at least one function (e.g., a function of adjusting the turn-on/off of the external electronic device itself (or some components thereof) or the brightness (or the resolution) of the display) of the external electronic device communicating with the electronic device, and may manage (e.g., install, delete, or update) an application operating in the external electronic device or a service (e.g., a call service or a messaging service) provided in the external electronic device.

The applications 370 may include an application (e.g., a healthcare application for a mobile medical device) corresponding to properties of the external electronic device.

The applications 370 may include an application received or downloaded from the external electronic device and/or a preloaded application or a third party application that can be downloaded from the server.

The names of the components of the program module 310 may vary depending on the type of the OS.

At least a part of the program module 310 may be implemented by software, firmware, hardware, or a combination thereof. At least a part of the program module 310 may be implemented (e.g., executed) by a processor. At least a part of the program module 310 may include a module, a program, a routine, an instruction set or a process, for performing one or more functions.

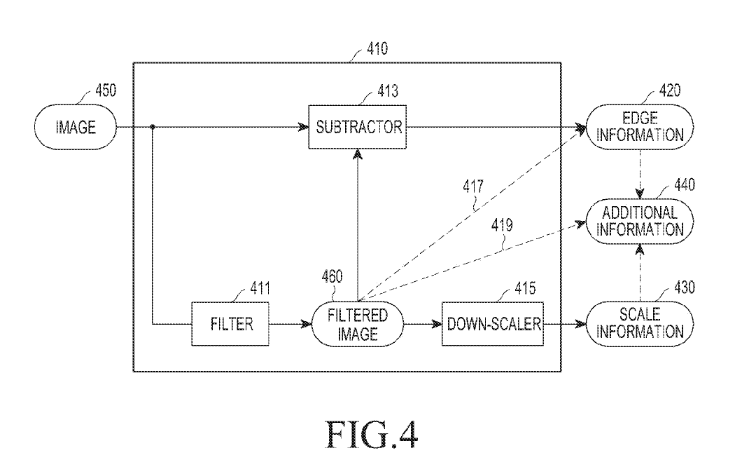

FIG. 4 illustrates a method of generating image information by an electronic device according to an embodiment of the present disclosure.

Referring to FIG. 4, an image processing module 410 of the electronic device includes a filter 411, a subtractor 413, and a down-scaler 415. Alternatively, the image processing module 410 may omit at least one of the above components or additionally include other components (e.g., a delay).

The image processing module 410 may be included in the image processing module 140 illustrated in FIG. 1.

The image processing module 410 generates edge information 420 of an image 450, by filtering the input image 450 using the filter 411. For example, the edge information 420 may include high-frequency component information of the image 450. The high-frequency component information of the image 450 may include information related to a contour representing the shape of an object included in the image 450, a sharp portion of the object, or a portion where the color of the object changes rapidly.

The filter 411 may include at least one of a Gaussian filter or a low-pass filter. Accordingly, the image processing module 410 may filter the input image 450 by passing the input image 450 through the Gaussian filter or the low-pass filter to leave the low-frequency component information.

The image processing module 410 may filter the input image 450 by down-scaling the input image 450 and then up-scaling the input image 450 back, in order to leave the low-frequency component information. For example, the image processing module 410 may generate the edge information 420 including the high-frequency component information by subtracting a filtered image 460 from which the low-frequency component information is mainly filtered, i.e., by subtracting the low-frequency component, from the input image 450 using the subtractor 413.

The image processing module 410 may insert a portion of the filtered image 460 into the edge information 420 or additional information 440.

In operation 417 or 419, the image processing module 410 inserts a remaining portion that is not down-scaled by the down-scaler 415, in the filtered image 460, into the edge information 420 or the additional information 440. The inserted portion may be used for restoring the image 450 without loss of image data, together with the portion down-scaled by the down-scaler 415 in the filtered image 460, when the image processing module 410 restores the image 450 back.

The image processing module 410 may generate scale information 430 of the image 450 by down-scaling the filtered image 460 using the down-scaler 415. For example, the down-scaled image may have a lower resolution than the image 450. The image processing module 410 may generate the scale information 430 by sampling the filtered image 460 at a predetermined ratio.

The image processing module 410 may generate the additional information 440 related to the image 450 based on the edge information 420, the scale information 430, or the filtered image 460. For example, the image processing module 410 may insert some of the edge information 420, some of the scale information 430, or a portion of the filtered image 460, into the additional information 440.

For example, the image processing module 410 may process an image using the inserted edge information 420, the inserted scale information 430, or the inserted portion of the filtered image 460, thereby making it possible to quickly process the image 450 as compared with processing the image using all of the edge information 420, all of the scale information 430, or the entire filtered image 460. The size (or amount) of the additional information 440 including the inserted edge information 420, the inserted scale information 430, or the portion of the filtered image 460 may be less than the size of the edge information 420, the size of the scale information 430, or the size of the filtered image 460.

The additional information 440 may include at least one of binary data of the edge information 420 or the scale information 430, high-frequency component information (e.g., a contour of an object, a sharp portion, etc.), color information (e.g., color distribution, gamma, etc.), brightness information (e.g., per-pixel brightness, overall average brightness, etc.), pattern information (e.g., the presence/absence of a pattern, the position of the pattern, the cycle of the pattern, etc.), motion information (e.g., the presence/absence of a motion, the position of the motion, the direction of the motion, etc.), or a black level value.

The image processing module 410 may insert the high-frequency component information of the image 450, which is included in the edge information 420, into the additional information 440. For example, the image processing module 410 may extract the high-frequency component information of the image 450 by subtracting the filtered image 460 from which the low-frequency component of the image 450 is filtered, from the image 450 using the subtractor 413. For example, when the image processing module 410 processes the image 450 (e.g., performs anti-aliasing detail enhancement (AADE), edge enhancement, noise reduction, etc.) using the high-frequency component information, the image processing module 410 may use the high-frequency component information included in the additional information 440, without again extracting the high-frequency component information from the image 450 or the edge information 420. The image processing module 410 may insert into the additional information 440 only the brightness information in the color information (e.g., color distribution, gamma, etc.) and the brightness information (e.g., per-pixel brightness, overall average brightness, etc.) that is included in the high-frequency component information, and then use the inserted brightness information in the future, to process the image (e.g., perform edge enhancement) with a less information than when processing the image using all of the high-frequency component.

The image processing module 410 may insert the binary data of the edge information 420 or the scale information 430 into the additional information 440. For example, the image processing module 410 may generate the binary data of the edge information 420 or the scale information 430 by coding as ‘1’, the information included in a specific range of the edge information 420 or the scale information 430, and coding as ‘0’, the information that is not included in the specific range.

The image processing module 410 may generate the binary data by converting into ‘0’, which represents white, the portion representing a gradation that is greater than or equal to a half gradation (e.g., a gradation of 128) of the maximum gradation (e.g., a gradation of 256) in the brightness information for each portion of the image 450, which is included in the edge information 420 or the scale information 430, and converting into ‘1’, which represents black, the portion representing a gradation that is lower than the half gradation.

Upon identifying specific information (e.g., character recognition) from the image 450, the image processing module 410 may use the binary data included in the additional information 440, without reconverting the edge information 420 or the scale information 430 into the binary data.

The image processing module 410 may insert the brightness information of the image 450, which is included in the scale information 430, into the additional information 440. For example, the image processing module 410 may extract the brightness information of the image 450 from the down-scaled image included in the scale information 430, and insert the extracted brightness information into the additional information 440. When the image processing module 410 changes the brightness of the image 450 displayed on the display in whole or in part, the image processing module 410 may change the brightness of the image 450 using the brightness information included in the additional information 440, without re-extracting the brightness information of the image 450 from the image 450 or the scale information 430.

The image processing module 410 may insert, into the additional information 440, the information obtained in the process of processing the image 450 (e.g., obtained in a part of an image pipeline). The image pipeline may include a series of image processing operations for obtaining a preset image for the image 450, before capturing the image 450.

The image pipeline may include a black level compensation (BLC) operation, an auto white balance (AWB) operation, an auto exposure (AE) operation, a lens shading (LS) operation, an edge extraction (EE) operation, a color correction (CC) operation, a noise reduction (NR) operation, a scaling operation, and/or a codec processing operation. The operations of the image pipeline may be performed in sequence, or the multiple operations may proceed substantially at the same time, in parallel, or in different orders.

The image processing module 410 may insert, into the additional information 440, a black level value of the image 450, which is obtained in the black level compensation operation.

The image processing module 410 may insert, into the additional information 440, the exterior lighting environmental information (e.g., color temperature) that is obtained in the auto white balance operation.

The image processing module 410 may insert, into the additional information 440, the overall average brightness of the image 450, which is obtained in the auto exposure operation.

The image processing module 410 may insert, into the additional information 440, the per-pixel brightness information of the image 450, which is obtained in the lens shading operation.

The image processing module 410 may insert, into the additional information 440, the per-pixel high-frequency component information of the image 450, which is obtained in the edge extraction operation.

The image processing module 410 may insert, into the additional information 440, the color distortion information (e.g., a difference between the theoretical color based on the color model and the actually implemented color) of the image 450, which is obtained in the color correction operation.

The image processing module 410 may insert, into the additional information 440, the per-pixel noise information (e.g., the presence/absence of noise, the intensity of the noise, the type of the noise, etc.) of the image 450, which is obtained in the noise reduction operation.

The image processing module 410 may insert, into the additional information 440, the high-frequency component information or per-pixel pattern information of the image 450, which is obtained in the scaling operation.

The image processing module 410 may insert, into the additional information 440, the motion vector information in units of macro block, which is obtained in the codec processing operation. For example, when an object in a first position of the image 450 is in a second position of another image that is to be displayed in sequence following the image 450, the motion vector information may include information about a vector from the first position to the second position.

The image processing module 410 may insert the information (e.g., high-frequency component information) obtained in the first operation (e.g., the scaling operation) of the image pipeline into the additional information 440, and process the image 450 using the information (e.g., high-frequency component information) included in the additional information 440 in the second operation (e.g., the edge extraction operation) of the image pipeline.

The image processing module 410 may process the image 450 (e.g., determine a prediction mode) using in a codec the information (e.g., information about the occurrence/non-occurrence of noise or motion) that is obtained in the image pipeline (e.g., the noise reduction operation) and inserted into the additional information 440.

The image processing module 410 may, for example, process the image 450 (e.g., adjust the brightness of the image 450 according to the color temperature of the external lighting), using the information (e.g., the color temperature of the external lighting) that is obtained in the image pipeline (e.g., the white balance operation) and inserted into the additional information 440, in a specific operation (e.g., my color management (MCM) operation) included in the output signal processing (OSP).

The image processing module 410 may process the image 450 (e.g., perform character recognition) using the information (e.g., binarized edge information) that is obtained in the image pipeline (e.g., the edge extraction operation) and inserted into the additional information 440, in the computer vision (CV) or an application.

The additional information 440 may include at least a portion of the filtered image 460. For example, the image processing module 410 may insert, into the additional information 440, the information (e.g., image data for the remaining portion) related to the remaining portion, except for the portion of the filtered image 460 down-scaled by the down-scaler 415. The information inserted into the additional information 440 may be used when the image processing module 410 restores the image 450, without loss of the image 450, using the down-scaled portion.

The image processing module 410 may insert context information related to the image 450 into the additional information 440. For example, the image processing module 410 may insert, into the additional information 440, figures information (e.g., name, phone number, Email address, home address, figures image, relationship with specific figures, etc.), location information (e.g., mountain, sea, etc.), things information (e.g., flower, food, etc.), time information (e.g., autumn, morning, etc.), event information (e.g., wedding, birthday, trip to a particular area, etc.), sound information (e.g., surrounding sound during photographing), photographing environmental information (e.g., photographing location, photographing direction, set value of photographing device, etc.), or thumbnail image information (e.g., image data for thumbnail images, context information extracted from the thumbnail images, or the like) related to the image 450.

The image processing module 410 may insert the figures information related to the image 450 into the additional information 440. For example, the image processing module 410 may obtain address book information for the figures (e.g., name, phone number, Email address, home address, figures image, relationship with address book user, etc.) corresponding to the subject in the image 450. For example, the image processing module 410 may obtain the address book information from a memory included in the electronic device, or from an external device.

The image processing module 410 may identify the address book information corresponding to the subject in the image 450 based on the comparison between the figures images included in the obtained address book information and the features of at least one subject included in the image 450. For example, the image processing module 410 may insert the address book information corresponding to the subject in the image 450 into the additional information 440, as figures information of the image 450.

The image processing module 410 may insert location information related to the image 450 into the additional information 440. For example, the image processing module 410 may determine the place where the image 450 is captured (e.g., mountain, sea, etc.), by identifying GPS information of the photographing device used to capture the image 450, from the photographing environmental information related to the image 450. The image processing module 410 may determine the place where the image 450 is captured, based on the comparison between the image 450 and the features of the sample image for the place. The image processing module 410 may also obtain information about the place where the image 450 is captured, based on the user input related to the image 450. The image processing module 410 may insert location information that is automatically determined or obtained based on the user input, into the additional information 440 as location information of the image 450.

The image processing module 410 may insert things information related to the image 450 into the additional information 440. For example, the image processing module 410 may identify at least one thing included in the image 450 (e.g., flower, food, etc.) based on at least one image processing technique (e.g., edge detection). The image processing module 410 may identify a thing, based on a comparison between the identified thing and features of a sample image for the thing. The image processing module 410 may also obtain information about the things included in the image 450 based on user input related to the image 450. For example, the image processing module 410 may insert the things information that is automatically determined or obtained through user input, into the additional information 440 as things information for the image 450.

The image processing module 410 may insert time information related to the image 450 into the additional information 440. For example, the image processing module 410 may determine the time at which the image 450 is captured (e.g., autumn, morning, etc.), by identifying the photographing time from the photographing environmental information related to the image 450. The image processing module 410 may obtain information about the time in which the image 450 is captured, based on the user input related to the image 450. For example, the image processing module 410 may insert the time information that is automatically determined or obtained through the user input, into the additional information 440 as time information for the image 450.

The image processing module 410 may insert event information related to the image 450 into the additional information 440. For example, the image processing module 410 may determine an event related to the capturing of the image 450, based on at least one of the figures information, the location information, the things information, or the schedule information. For example, the image processing module 410 may determine an event (e.g., wedding, birthday, trip to a particular area, etc.) related to the capturing of the image 450, based on the schedule information of the user of the electronic device or the figures corresponding to the subject.

For example, the image processing module 410 may identify the image 450 that is captured at the time corresponding to the schedule information, by comparing the schedule information with the time in which the image 450 is captured.

The image processing module 410 may determine which event is related to the capturing of the image 450, based on a comparison between at least a portion of the image 450 and the features of the sample image for the event.

The image processing module 410 may also obtain event information related to the image 450 based on the user input related to the image 450.

Accordingly, the image processing module 410 may insert the event information that is automatically determined or obtained through the user input, into the additional information 440 as event information for the image 450.

The image processing module 410 may insert sound information related to the image 450 into the additional information 440. For example, the image processing module 410 may obtain the surrounding sound information of the photographing device, which is obtained when the image 450 is captured. For example, the image processing module 410 may insert, into the additional information 440, sound data corresponding to the sound information or other information (e.g., location information, event information, etc.) that is determined based on the sound information.

The image processing module 410 may insert photographing environmental information related to the image 450 into the additional information 440. The photographing environmental information may include identification information, property information, and/or setting information related to a camera provided to capture the image 450. The identification information may include a manufacturer, a model, a serial number, or a tag of a mobile terminal including a camera.

The property information may include information related to a display, a lens, a codec, or a sensor included in the camera.

The setting information may include information related to a parameter or a control command, which is set in the camera. For example, the setting information may include information related to F-stop, shutter speed, international standard organization (ISO) sensitivity, zoom-in/out, resolution, filter, auto white balance, auto focus, high dynamic range, GPS, camera direction, location, flash rate, and/or frame rate.

The identification information, the property information, or the setting information may also include a variety of information, other than the examples of above.

The image processing module 410 may insert information related to thumbnail images related to the image 450 into the scale information 430 or the additional information 440. For example, the image processing module 410 may obtain information related to thumbnail images that are captured with the image 450.

The image processing module 410 may insert at least one piece of context information extracted from image data of thumbnail images or from thumbnail images into the scale information 430 or the additional information 440. For example, the image processing module 410 may identify the context information (e.g., location information or position information) that may not be identifiable from just the image 450, based on the image 450 and a plurality of thumbnail images.

The image processing module 410 may insert the context information identified from the thumbnail images into the additional information 440 as context information related to the image 450.

The image processing module 410 may insert depth information of the image 450 into the edge information 420, the scale information 430, or the additional information 440. For example, the image processing module 410 may insert first depth information for a first object and second depth information for a second object, the first and second objects being included in the image 450, into the edge information 420, the scale information 430, or the additional information 440.

The image processing module 410 may calculate a first vertical coordinate for the first object in the image 450 using the first depth information, and calculate a second vertical coordinate for the second object in the image 450 using the second depth information. For example, the image processing module 410 may generate three-dimensional (3D) information of the image 450 using the first vertical coordinate and the second vertical coordinate.

The image processing module 410 may insert at least one of the edge information 420, the scale information 430, or the additional information 440, as a portion of the image 450, e.g., into a header or metadata included in the image 450.

The image processing module 410 may insert at least one of the edge information 420, the scale information 430, or the additional information 440 into metadata that is stored separately from the image 450.

The image processing module 410 may insert the edge information 420, the scale information 430, and the additional information 440 into a plurality of fields (e.g., supplemental enhancement information (SEI), video usability information (VUI), etc.) that are included in the image 450 or separate metadata.

The image processing module 410 may transmit at least one of the edge information 420, the scale information 430, or the additional information 440 to an external device for the electronic device in which the image processing module 410 is included. For example, the image processing module 410 may transmit at least one of the edge information 420, the scale information 430, or the additional information 440 to the external device by inserting the information into the header, supplemental enhancement information, video usability information, or metadata included in the image 450. The image processing module 410 may also transmit at least one of the edge information 420, the scale information 430, or the additional information 440 to the external device by inserting the information into metadata that is separate from the image 450.

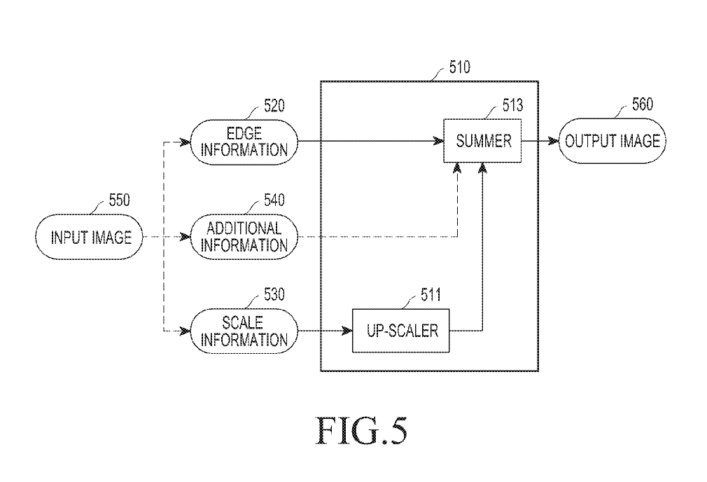

FIG. 5 illustrates a method of generating an output image using image information by an electronic device according to an embodiment of the present disclosure.

Referring to FIG. 5, an image processing module 510 of the electronic device includes an up-scaler 511 and a summer 513. Alternatively, image processing module 510 may omit at least one of the illustrated components or additionally include other components (e.g., a delay). For example, the image processing module 510 may be included in the image processing module 140 illustrated in FIG. 1.

The output image 560 may be a final image that can be displayed on a display, or an intermediate image in which at least a portion of an input image 550 is processed (e.g., for which edge enhancement is performed).

The image processing module 510 may obtain edge information 520, scale information 530, or additional information 540, included in the input image 550 or separate metadata, from a memory of the electronic device or from an external device. For example, the image processing module 510 may extract the edge information 520, the scale information 530, or the additional information 540 from the header, supplemental enhancement information, video usability information, or metadata included in the input image 550 or may obtain the edge information 520, the scale information 530, or the additional information 540 included in a plurality of fields included in the input image 550 or separate metadata. The additional information 540 may be generated based on some of the edge information 520 related to the input image 550 or some of the scale information 530. The edge information 520, the scale information 530, and the additional information 540 may be generated like the edge information 420, the scale information 430, and the additional information 440 illustrated in FIG. 4, respectively.

The image processing module 510 may generate the output image 560 using the edge information 520, the scale information 530, or the additional information 540 related to the input image 550. For example, the image processing module 510 may up-scale a down-scaled input image included in the scale information 530 using the up-scaler 511. The image processing module 510 may generate the output image 560 by summing up the up-scaled input image and the edge information 520 using the summer 513.

The image processing module 510 may generate the output image 560 using the additional information 540 including some of the edge information 520 or some of the scale information 530, instead of using all of the edge information 520 or all of the scale information 530. This makes it possible to more quickly generate the output image 560 as compared to using all of the edge information 520 or all of the scale information 530. Consequently, power consumed by the image processing module 510 may be less than when the image processing module 510 uses all of the edge information 520 or all of the scale information 530.

The image processing module 510 may generate the output image 560 using the additional information 540 including some of the edge information 520 and some of the scale information 530. For example, the image processing module 510 may perform up-scaling using some of the scale information 530 included in the additional information 540, and generate an output image from the image obtained by the up-scaling, using some of the edge information 520 included in the additional information 540. This makes it possible to more quickly generate the output image 560 as compared with using all of the edge information 520 or all of the scale information 530. Consequently, the power consumed by the image processing module 510 may be less than when the image processing module 510 uses all of the edge information 520 or all of the scale information 530.

The image processing module 510 may process the input image 550 using information obtained in the image pipeline and inserted into the additional information 540, e.g., information obtained in the first operation of the image pipeline and inserted into the additional information 540 in the second operation of the image pipeline.

For example, the image processing module 510 may use high-frequency component information of the input image 550, which is obtained in the scaling operation of the image pipeline and inserted into the additional information 540, in the edge extraction operation of the image pipeline. The image processing module 510 may enhance the edges of the input image 550 using the high-frequency component information included in the additional information 540, without extracting the high-frequency component information from the input image 550 or the edge information 520, in the edge extraction operation.

When the additional information 540 includes only the brightness information, except for the color information in the high-frequency component information, the image processing module 510 may enhance the edges of the input image 550 using only the brightness information. The edge enhancement may refer to enhancing the edges so that a contour or a line between the subject and the background, which is blurred due to the degradation or the out-of-focus, may be clearer.

The image processing module 510 may process the input image 550 using, in a codec, the information that is obtained in the image pipeline and inserted into the additional information 540. For example, the image processing module 510 may use, in the codec, the information about occurrence/non-occurrence of a motion, which is obtained when distinguishing a noise and a motion in the noise reduction operation, and inserted into the additional information 540.

The image processing module 510 may determine a prediction mode in the codec based on the occurrence/non-occurrence of a motion, which is included in the additional information 540. For example, the image processing module 510 may determine the prediction mode as an inter-prediction mode, if a motion has occurred, and may determine the prediction mode as an intra-prediction mode, if no motion has occurred.

The image processing module 510 may omit the motion estimation process of generating motion vector information in the codec, by converting information relating to the motion into motion vector information.

The image processing module 510 may process the input image 550 using information that is obtained in the image pipeline and inserted into the additional information 540, in the output signal processing operation. For example, the output signal processing operation may include processing the input image 550 to output or display the output image 560 on a display.

The image processing module 510 may adjust a high dynamic range (HDR) of the input image 550 by defining a black level value included in the additional information 540 as a reference value for the brightness of the input image 550. For example, the image processing module 510 may use the black level value of the input image 550, which is obtained in the black level compensation operation and inserted into the additional information 540, in the high dynamic range adjustment operation included in the output signal processing operation.

The image processing module 510 may change the brightness of at least a portion of the input image 550 based on the exterior lighting environmental information (e.g., the color temperature of the external lighting) included in the additional information 540. For example, the image processing module 510 may adjust the brightness of the input image 550 to correspond to the exterior lighting environmental information. For example, the image processing module 510 may use the exterior lighting environmental information that is obtained in the auto white balance operation and inserted into the additional information 540, in the my color management (MCM) operation included in the output signal processing operation.

The image processing module 510 may increase or decrease the overall brightness of the input image 550 based on the overall average brightness of the input image 550, which is included in the additional information 540. For example, the image processing module 510 may use the overall average brightness of the input image 550, which is obtained in the auto exposure operation and inserted into the additional information 540, in a global color enhancement (GCE) operation included in the output signal processing operation.

The image processing module 510 may adjust the brightness of a region of each portion included in the input image 550 based on per-pixel brightness information included in the additional information 540. For example, the image processing module 510 may adjust the brightness of a first region (e.g., a first pixel) included in the input image 550 by a first degree and adjust the brightness of a second region (e.g., a second pixel) by a second degree, using the per-pixel brightness information included in the additional information 540. The image processing module 510 may use the per-pixel brightness information of the input image 550, which is obtained in the lens shading operation and inserted into the additional information 540, in the local color enhancement (LCE) operation included in the output signal processing operation.

The image processing module 510 may enhance the color or brightness of a particular portion of the input image 550, based on the high-frequency component information of the input image 550, which is included in the additional information 540. For example, the image processing module 510 may change (e.g., increase) the color or brightness of a first portion of the input image 550, which corresponds to the high-frequency component information, and may not change the color or brightness of a second portion of the input image 550, which does not correspond to the high-frequency component information. The image processing module 510 may use the high-frequency component information of the input image 550, which is obtained in the edge extraction operation and inserted into the additional information 540, in the detail enhancement (DE) operation included in the output signal processing operation.

The image processing module 510 may generate a new color model in which a modified value for the distorted color is reflected in the color model (e.g., RGB, CMY, HIS and YCbCr) of the input image 550, based on the color distortion information included in the additional information 540. The image processing module 510 may change the criteria capable of determining that the color information (e.g., R, G, B, etc.,) included in the color model of the input image 550 is saturated, based on the color distortion information included in the additional information 540. The image processing module 510 may use the color distortion information of the input image 550, which is obtained in the color correction operation and inserted into to the additional information 540, as at least a portion of adaptive standard color representation (ASCR) information or color saturation (CS) information in the signal processing operation.

The image processing module 510 may process the image 550 in computer vision (CV) or an application using the information that is obtained in the image pipeline and inserted into the additional information 540. For example, the image processing module 510 may perform a recognition algorithm (e.g., character recognition) in the CV or the application, using the binarized edge information that is extracted in the edge extraction process and inserted into the additional information 540. The image processing module 510 may perform the recognition algorithm by comparing the binarized edge information with the binarized sample characters.

The image processing module 510 may generate the output image 560 using the additional information 540 that is generated based on the edge information 520 or the scale information 530. For example, the image processing module 510 may generate the output image 560 by summing up at least some of the edge information 520 (e.g., down-scaled edge information) and the scale information 530, which are included in the additional information 540, using the summer 513. The image processing module 510 may use some of the edge information 520, which is included in the additional information 540, instead of the edge information 520, which makes it possible to more quickly generate the output image 560 than when using all of the edge information 520.

The image processing module 510 may generate the output image 560 that is substantially identical to the input image 550. For example, the image processing module 510 may generate the output image 560 that is visually lossless or data lossless, compared with the input image 550. The output image 560 may be visually lossless when, even though there is image data that is included in the input image 550 but not included in the output image 560, the difference between the image data is not recognizable by the user. The output image 560 may be data lossless when the output image 560 includes image data that is identical to the image data included in the input image 550.

The image processing module 510 may generate the output image 560 based on context information related to the input image 550, which is included in the additional information 540. For example, by comparing the context information included in the additional information 540 with context information included in another image, the image processing module 510 may generate the output image 560 including another image that includes context information identical or similar to that of the input image 550. The image processing module 510 may generate the output image 560 on which another image including context information that is identical or similar to that of the input image 550, and the input image 550 are disposed together in the picture-in-picture form or in the files-in-folder form. The image processing module 510 may generate the output image 560 on which the context information included in the additional information 540 is displayed in the form of text or graphic user interface in a portion of the input image 550.

The image processing module 510 may generate the output image 560 on which the input image 550, and another image including context information (e.g., figures information, location information, things information, time information, event information, sound information, shooting environmental information and the like) that is identical or similar to that of the input image 550 are disposed together, based on the additional information 540. For example, the image processing module 510 may generate the output image 560 with a plurality of images, on which the input image 550 including first context information (e.g., France) is disposed in a first position (e.g., top) in the output image 560, and another image including second context information (e.g., Switzerland) is disposed in a second position (e.g., bottom) in the output image 560. For example, the image processing module 510 may dispose a first other image and the input image 550 including the first context information (e.g., France) to be adjacent to an indication (e.g., text or icon indicating France) indicating the first context information included in the output image 560, and dispose a second other image and a third other image including the second context information (e.g., Switzerland) to be adjacent to an indication (e.g., text or icon indicating Swiss) indicating the second context information. The image processing module 510 may generate the output image 560 on which the other images and the input image 550 are disposed in the order (e.g., in the shooting time order) of the context information (e.g., time information). If the output image 560 is displayed on the display, an image on which at least two or more of the input image 550, the first other image, the second other image, or the third other image are disposed together may be displayed as the output image 560.

The image processing module 510 may generate, based on the additional information 540, the output image 560 that includes a menu for selectively displaying the first other image and the input image 550 including first context information (e.g., work colleagues), or the second other image and the third other image including second context information (e.g., family) For example, the image processing module 510 may generate the output image 560 that includes a menu at a portion of the output image 560, or that is configured with a hidden menu that may be shown in response to a user input for a portion of the output image 560. For example, the image processing module 510 may generate the output image 560, on which if the first context information is selected on the menu by a user input, the first other image the input image 550 can be displayed, and if the second context information is selected on the menu by a user input, the second other image and the third other image can be displayed. When the output image 560 is displayed on the display, a menu for the input image 550, the first other image, the second other image, or the third other image may be displayed as at least a portion of the output image 560. For example, at least one of the input image 550, the first other image, the second other image, or the third other image may be displayed in response to an input that is made for the menu on the display.

The image processing module 510 may generate the output image 560 on which context information included in the additional information 540 is displayed in the form of text, in a portion of the input image 550. For example, the image processing module 510 may generate a phrase (e.g., a trip to Seoul) related to the context information, by adding a predetermined word to the text (e.g., Seoul) corresponding to the context information (e.g., location information). The image processing module 510 may display a phrase in which a plurality of context information included in the additional information 540 are connected to each other, in a portion of the input image 550.

The image processing module 510 may display a text indicating that specific figures have been taken at a particular time in a particular location, in a portion of the input image 550. For example, the image processing module 510 may obtain the text related to the context information through learning (e.g., deep learning) By learning the context information included in other images, the image processing module 510 may automatically determine in which text it will display the context information included in the input image 550.

The image processing module 510 may generate the output image 560 on which context information included in the additional information 540 is displayed in a portion of the input image 550 in the form of a GUI. For example, the image processing module 510 may store, in advance, a graphic user interface corresponding to the context information (e.g., figures information, location information, things information, time information, event information, sound information, shooting environmental information, etc.). For example, the image processing module 510 may display the graphic user interface (e.g., a house-shaped figure) corresponding to specific context information (e.g., house) in a portion of the input image 550.

The image processing module 510 may generate the output image 560 based on the update of the additional information 540. For example, the image processing module 510 may generate the output image 560 based on the updated additional information 540, in response to detection of the update of the additional information 540.

The additional information 540 may be updated while processing the input image 550 by the image processing module 510, or updated in an external device for the electronic device including the image processing module 510. For example, when the image processing module 510 uses second additional information (e.g., brightness information of the scale information 530) and the first additional information (e.g., high-frequency component information of the edge information 520) included in the additional information 540 to process the input image 550, the image processing module 510 may update the additional information 540 so that the additional information 540 may include the first additional information and the second additional information. For example, when first context information included in the additional information 540 is changed to second context information, the image processing module 510 may generate the output image 560 on which other images including the second context information are displayed together with the input image 550, or the output image 560 on which the second context information can be displayed in the form of text or graphic user interface in a portion of the input image 550.

The image processing module 510 may generate the output image 560 including at least a portion of the input image 550 or at least a portion of a thumbnail image, based on the information related to the thumbnail image, which is included in the scale information 530 or the additional information 540. For example, the image processing module 510 may generate the output image 560 by synthesizing the input mage 550 and the thumbnail image related to the input image 550. The image processing module 510 may generate the output image 560 by synthesizing the main frames extracted from a plurality of thumbnail images into a panoramic image. The image processing module 510 may generate the output image 560 on which the input image 550 and the thumbnail image related to the input image 550 are disposed in the picture-in-picture form or in the files-in-folder form. For example, the image processing module 510 may display other images related to the thumbnail image, in response to an input for a portion corresponding to the thumbnail image in the output image 560 displayed on the display.

The image processing module 510 may generate the output image 560 in 3D, based on the depth information (e.g., per-pixel/object vertical coordinates) included in the edge information 520, the scale information 530, and/or the additional information 540. For example, the image processing module 510 may calculate a first vertical coordinate in the input image 550 of a first object using first depth information for the first object included in the input image 550, and calculate a second vertical coordinate in the input image 550 of a second object using second depth information for the second object. The image processing module 510 may generate 3D information of the input image 550 based on the first vertical coordinate and the second vertical coordinate. The image processing module 510 may generate the output image 560 using the 3D information. For example, the output image 560 in 3D may be an image on which the first object and the second object are expressed in 3D (e.g., a 3D map) or an image on which the object can be displayed differently, e.g., in a first case where a first input of the user for the object is made based on a first pressure and a second case where a second input for the object is made based on a second pressure.

The image processing module 510 may display the output image 560 on a display that is functionally connected to the image processing module 510. For example, the image processing module 510 may display the output image 560 in which at least a portion of the input image 550 is changed. For example, the image processing module 510 may display the output image 560 for which image processing for the input image 550 is performed, in place of the input image 550. The display may be mounted in the electronic device including the image processing module 510, or mounted in the external device for the electronic device.

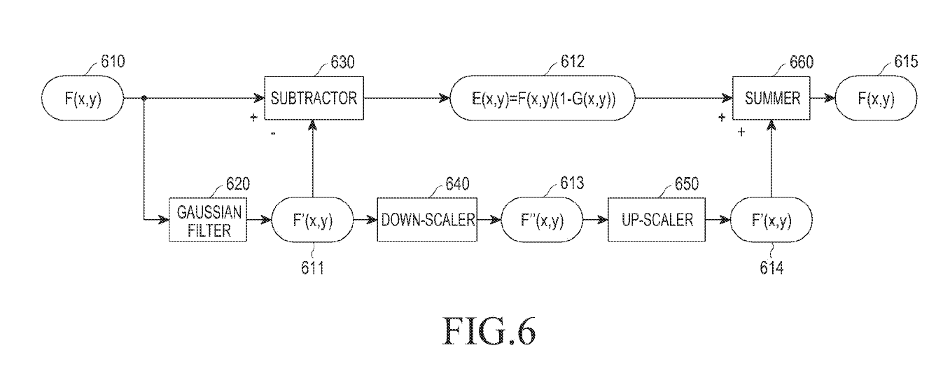

FIG. 6 illustrates a method of restoring an image without visual loss by an electronic device according to an embodiment of the present disclosure.

Referring to FIG. 6, an image processing module of the electronic device includes a Gaussian filter 620, a subtractor 630, a down-scaler 640, an up-scaler 650, and a summer 660.

An input image corresponds to a two-dimensional (2D) input image function F(x,y) 610 in the frequency domain. The input image function F(x,y) 610 may be filtered into a filtered image function F′(x,y) 611 by the Gaussian filter 620. The Gaussian filter 620 may be expressed as a function G(x,y), as shown in Equation (1) below, where σ denotes a standard deviation of the input image function F(x,y) 610.

$$G ( x , y ) = \frac{1}{2 {πσ}^{2}} {e}^{- \frac{{x}^{2} + {y}^{2}}{2 {σ}^{2}}} \qquad ( 1 )$$

The image function F′(x,y) 611 filtered by the Gaussian filter 620 may be expressed as operation of the input image function F(x,y) 610 and the Gaussian filter G(x,y) 620, as shown in Equation (2) below.

F′(x,y)=F(x,y)·G(x,y) (2)

The image function 611 filtered from the input image function 610 may be subtracted by the subtractor 630. The result obtained by subtracting the image function 611 filtered from the input image function 610 may be expressed as an edge function E(x,y) 612. The edge function E(x,y) 612 may be expressed as a difference between the input image function 610 and the filtered image function 611, as shown in Equation (3) below.

E(x,y)=F(x,y)−F′(x,y)=F(x,y)−F(x,y)·G(x,y)=F(x,y)(1−G(x,y)) (3)

The filtered image function 611 may be down-scaled into a down-scaled image function F″(x,y) 613 by the down-scaler 640. The down-scaler 640 may be expressed as a function p(x,y), as shown in Equation (4) below.

$$p ( x , y ) = {\sum }_{i = 0}^{3} {\sum }_{j = 0}^{3} {a}_{ij} {x}^{i} {y}^{j} \qquad ( 4 )$$

The down-scaled image function F″(x,y) 613 may be expressed as an operation of the filtered image function F′(x,y) 611 and the down-scaler p(x,y) 415, as shown in Equation (5) below.

F″(x,y)=F′(x,y)·p(x,y) (5)

The down-scaled image function F″(x,y) 613 may be up-scaled into an up-scaled image function F′(x,y) 614 by the up-scaler 650. Here, p⁻¹(x, y), which is an inverse function of p(x,y), may be a function for up-scaling F′(x,y). For example, assuming that p⁻¹(x, y) is an ideal inverse function for p(x,y), the up-scaled image function F′(x,y) 614 may be expressed as a function identical to the filtered image function F′(x,y) 611, as shown in Equation (6) below.

F′(x,y)=F″(x,y)·p⁻¹(x,y) (6)

The edge function E(x,y) 612 and the up-scaled image function F′(x,y) 614 may be summed up into an output image function F(x,y) 615 by the summer 660. The process in which the output image function F(x,y) 615 is summed, based on the edge function E(x,y) 612 and the up-scaled image function F′(x,y) 614, may be expressed as shown in Equation (7) below.

$$\begin{matrix}F ( x , y ) = {F}^{′} ( x , y ) + E ( x , y ) \\ = {F}^{′} ( x , y ) + F ( x , y ) ( 1 - G ( x , y ) ) \\ = {F}^{′} ( x , y ) + F ( x , y ) - F ( x , y ) G ( x , y ) \\ = {F}^{′} ( x , y ) + F ( x , y ) - {F}^{′} ( x , y ) \\ = F ( x , y )\end{matrix} \qquad ( 7 )$$

According to Equations (1) to (7) above, if p⁻¹(x, y) in Equation (6) is an ideal inverse function of p(x,y), the input image function F(x,y) 610 may be restored into the output image function F(x,y) 615, without visual loss or data loss.

If p⁻¹(x, y) in Equation (6) is not an ideal inverse function of p(x,y), the output image function 615, in which at least a portion of the input image function 610 is lost, may be generated.

The image processing module may set p⁻¹(x, y) so that a degree (e.g., a difference between an input image and an output image), at which at least a portion of the input image function 610 is lost, may not be recognizable by human eyes. For example, p⁻¹(x, y) may be a function that is more complex as the function is closer to an ideal inverse function of p(x,y).

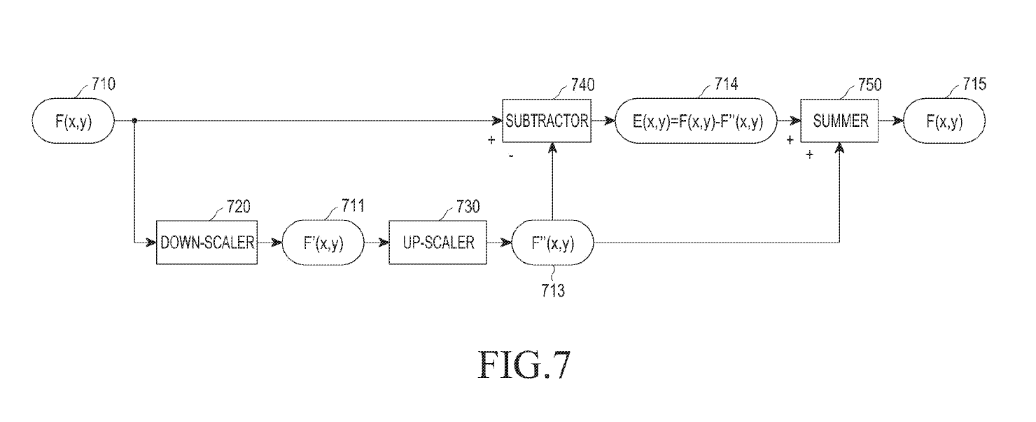

FIG. 7 illustrates a method of restoring an image without data loss by an electronic device according to an embodiment of the present disclosure.

Referring to FIG. 7, the image processing module includes a down-scaler 720, an up-scaler 730, a subtractor 740, and a summer 750. An input image may correspond to a 2D input image function F(x,y) 710 in the frequency domain. The input image function F(x,y) 710 may be down-scaled into a down-scaled image function F′(x,y) 711 by the down-scaler 720. The down-scaler 720 may be expressed as shown in Equation (8) below.

$$p ( x , y ) = {\sum }_{i = 0}^{3} {\sum }_{j = 0}^{3} {a}_{ij} {x}^{i} {y}^{j} . \qquad ( 8 )$$

The image function F′(x,y) 711 down-scaled by the down-scaler 720 may be expressed as an operation of the input image function F(x,y) 710 and the down-scaler p(x,y) 720, as shown in Equation (9) below.

F′(x,y)=F(x,y)·p(x,y) (9)

The down-scaled image function F″(x,y) 711 may be up-scaled into an up-scaled image function F′(x,y) 713 by the up-scaler 730. Here, p⁻¹(x, y), which is an inverse function of p(x,y), may mean a function for up-scaling F′(x,y). If p⁻¹(x, y) is an ideal inverse function for p(x,y), the up-scaled image function F″(x,y) 713 may be expressed as a function identical to the input image function F(x,y) 710.

If p⁻¹(x, y) is not an ideal inverse function of p(x,y), the up-scaled image function F″(x,y) 713 may be expressed as shown in Equation (10) below.

F″(x,y)=F′(x,y)·p⁻¹(x,y) (10)

The image function 713 up-scaled from the input image function 710 may be subtracted by the subtractor 740. The result obtained by subtracting the image function 713 up-scaled from the input image function 710 may be expressed as an edge function E(x,y) 714. The edge function E(x,y) 714 may be expressed as a difference between the input image function F(x,y) 710 and the up-scaled image function F″(x,y) 713, as shown in Equation (11) below.

E(x,y)=F(x,y)−F″(x,y) (11)

The edge function E(x,y) 714 and the up-scaled image function F″(x,y) may be summed up into an output image function F(x,y) 715 corresponding to the output image by the summer 750. The process in which the output image function F(x,y) 715 is summed based on the edge function E(x,y) 714 and the up-scaled image function F″(x, y) 713 may be expressed as shown in Equation (12) below.

$$\begin{matrix}F ( x , y ) = F ( x , y ) + F ( x , y ) - F ( x , y ) \\ = F ( x , y )\end{matrix} \qquad ( 12 )$$

According to Equations (8) to (12), the image processing module may generate the output image function 715 being identical to the input image function 710, by adding the up-scaled image function F″(x,y) 713 to a value obtained by subtracting the up-scaled image function F″(x,y) 713 from the input image function F(x,y) 710. Therefore, regardless of p⁻¹(x, y) in Equation (10) being an ideal inverse function of p(x,y), the input image function 710 may be restored into the output image function 715, without data loss.

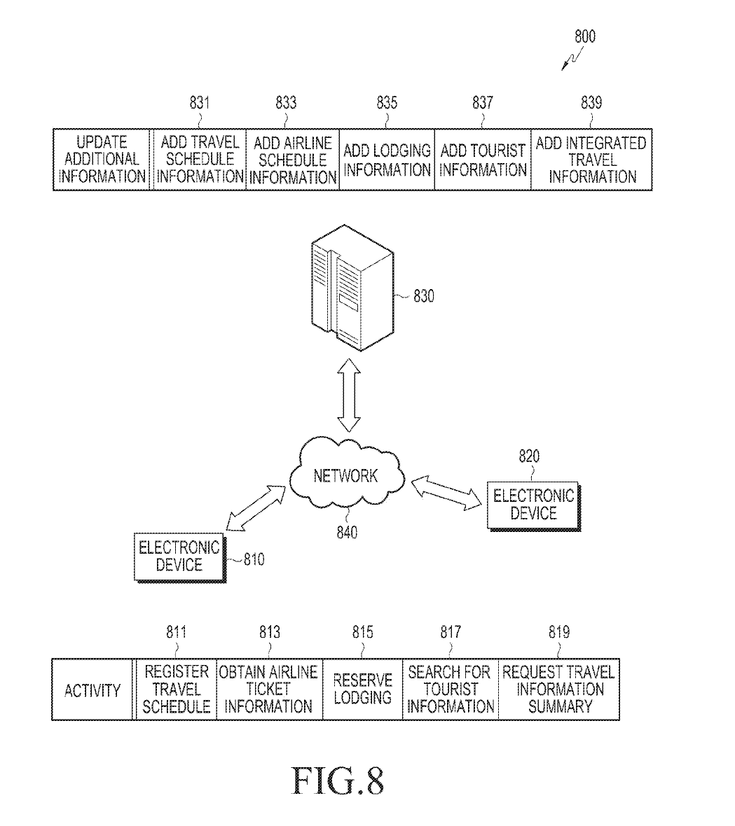

FIG. 8 illustrates a method of updating additional information by an electronic device in a network environment according to an embodiment of the present disclosure.

Referring to FIG. 8, the network environment includes an electronic device 810, an external device 820, and a server 830. The electronic device 810, the external device 820, and/or the server 830 may each include an image processing module.

The server 830 may update additional information related to an image, based on at least one activity that has occurred in the electronic device 810. For example, the electronic device 810 may transmit, to the server 830, the activity that has occurred in the electronic device 810. The server 830 may analyze the activity received from the electronic device 810, identify an image related to the analysis result, and insert the analysis result as at least some of additional information included in the image.

In operation 811, the electronic device 810 may register a travel schedule in a schedule application included in the electronic device 810. For example, the electronic device 810 may register a travel schedule in a schedule application based on the user input or the information that the electronic device 810 has automatically obtained from other applications (e.g., an Email application). The electronic device 810 may transmit at least some of the information included in the registered travel schedule, to the server 830.

In operation 831, the server 830 may update additional information included in at least one image (e.g., an image captured during the travel schedule) related to the travel schedule included in the received travel schedule information. The server 830 may associate the image with other images captured during the same travel schedule, based on the updated additional information. When the image is displayed on a display that is functionally connected to the server 830, other images captured during the same travel schedule may be displayed in association with the image. The server 830 may insert the text (e.g., 11/19˜11/21) related to the travel schedule in a portion of the image based on the updated additional information. The server 830 may transmit the image that includes additional information in which the travel schedule is updated, or that is processed based on the updated additional information, to the electronic device 810 or the external device 820.

In operation 813, the electronic device 810 may obtain airline ticket information. For example, the electronic device 810 may receive an airline ticket (e.g., an e-ticket) through an Email. The electronic device 810 may obtain information related to the airline ticket through an airline ticket application. The electronic device 810 may transmit the received airline ticket information to the server 830.

In operation 833, the server 830 may update additional information included in at least one image (e.g., an image captured during airline schedule) related to an airline schedule included in the received airline ticket information. The server 830 may associate the image with other images captured during the same airline schedule based on the updated additional information. For example, when the image is displayed on a display that is functionally connected to the server 830, other images captured during the same airline schedule may be displayed in association with the image. The server 830 may insert the text (e.g., PM 5:00, 11/19, Inchon [symbol] Paris, KE901) related to the airline schedule in a portion of the image based on the updated additional information. The server 830 may transmit the image that includes additional information in which the airline schedule is updated, or that is processed based on the updated additional information, to the electronic device 810 or the external device 820.

In operation 815, the electronic device 810 may reserve lodging through a web site. For example, the electronic device 810 may reserve lodging based on a user input in the homepage of the lodging (e.g., hotel) on a browser, and obtain the relevant information. The electronic device 810 may obtain information related to the lodging through a lodging application. The electronic device 810 may transmit the obtained lodging information to the server 830.

In operation 835, the server 830 may update additional information included in at least one image (e.g., an image captured within the lodging or in the area where the lodging is located) related to the lodging included in the received lodging information. The server 830 may associate the image with other images captured within the same lodging or in the same area where the lodging is located, based on the updated additional information. For example, when the image is displayed on a display that is functionally connected to the server 830, other images captured within the same lodging or in the same area where the lodging is located, may be displayed in association with the image. For example, the server 830 may insert the text (e.g., Check-in, Hyatt Hotel, PM 2:00, 11/20˜22) related to the lodging information in a portion of the image, based on the updated additional information. The server 830 may transmit the image that includes additional information in which the lodging schedule is updated, or that is processed based on the updated additional information, to the electronic device 810 or the external device 820.

In operation 817, the electronic device 810 may search for tourist information. For example, the electronic device 810 may obtain tourist information related to a particular location based on the user's input through a browser. The electronic device 810 may transmit the obtained tourist information to the server 830.

In operation 837, the server 830 may update additional information included in at least one image (e.g., an image captured in France) related to a tourist place (e.g., France) included in the received tourist information. The server 830 may associate the image with other images captured in the same tourist place based on the updated additional information. For example, when the image is displayed on a display that is functionally connected to the server 830, other images captured in the same tourist place may be displayed in association with the image. For example, the server 830 may insert the text (e.g., in front of the Louvre museum in France) related to the tourist information in a portion of the image, based on the updated additional information. The server 830 may transmit the image that includes additional information in which the tourist information is updated, or that is processed based on the updated additional information, to the electronic device 810 or the external device 820.

In operation 819, the electronic device 810 may request a summary of travel information from the server 830. For example, the electronic device 810 may request, from the server 830, a summary of travel information that has been obtained until the requested time, based on the user input. The electronic device 810 may request, from the server 830, a summary of travel information that has been periodically obtained without the user input.

In operation 839, the server 830 may update additional information by integrating the cumulatively obtained travel information. For example, the server 830 may update the additional information based on the information obtained in operations 831 to 837 and other information. For example, the server 830 may associate the travel schedule updated in the additional information in operation 831, the airline schedule updated in operation 833, the lodging information updated in operation 835, and/or the tourist information updated in operation 837, with the travel information to a particular place (e.g., France). The server 830 may update additional information so that the travel information may include some of the event information (e.g., honeymoon information), based on the event information (e.g., a wedding schedule) that is obtained from the electronic device 810 with respect to the travel information to a particular place (e.g., France).

In various embodiments, an electronic device for processing a plurality of images may include a memory for storing an image, and an image processing module that is functionally connected to the memory.

In various embodiments, the image processing module may obtain additional information generated based on some of edge information or some of scale information related to an input image.

In various embodiments, the image processing module may generate an output image corresponding to at least a portion of the input image based on the obtained additional information.

In various embodiments, the image processing module may obtain the scale information and the edge information including an image down-scaled from the input image.

In various embodiments, the image processing module may up-scale the down-scaled image.

In various embodiments, the image processing module may generate the output image further based on at least one of the up-scaled image or the edge information.

In various embodiments, the additional information may be used in place of at least one of the scale information or the edge information.

In various embodiments, the image processing module may generate the output image so that the output image may be substantially identical to the input image.

In various embodiments, the output image may be visually lossless or data lossless with respect to the input image.

In various embodiments, the additional information may be less in size than the edge information or the scale information.

In various embodiments, the additional information may be information that is generated based on some of the edge information or some of the scale information, when the input image is processed in an image pipeline (e.g., a black level compensation operation, an auto white balance operation, an auto exposure operation, an lens shading operation, an edge extraction operation, a color correction operation, a noise reduction operation, a scaling operation, a codec processing operation or the like) for the input image.

In various embodiments, the additional information may include at least one of binary data of the edge information or the scale information, high-frequency component information (e.g., a contour of an object, a sharp portion and the like), color information (e.g., color distribution, gamma and the like), brightness information (e.g., per-pixel brightness, overall average brightness and the like), pattern information (e.g., the presence/absence of a pattern, the position of the pattern, the cycle of the pattern, and the like), motion information (e.g., the presence/absence of a motion, the position of the motion, the direction of the motion, and the like), or a black level value.

In various embodiments, the image processing module may generate the output image on which at least one image processing among anti-aliasing detail enhancement (AADA), edge enhancement or detail enhancement is performed for the input image, using high-frequency component information of the edge information included in the additional information.

In various embodiments, the image processing module may generate the output image on which the brightness of at least a portion of the input image is changed, using the brightness information of the scale information included in the additional information.

In various embodiments, the additional information may include at least one of figures information, location information, things information, time information, event information, shooting environmental information or thumbnail image information related to the input image.

In various embodiments, the image processing module may associate the input image with at least one other image, based on at least one of figures information (e.g., name, phone number, Email address, home address, figures image, relationship with specific figures, or the like), location information (e.g., mountain, sea or the like), things information (e.g., flower, food or the like), time information (e.g., autumn, morning or the like), event information (e.g., wedding, birthday, trip to a particular area, or the like), sound information (e.g., surrounding sound during shooting), shooting environmental information (e.g., shooting location, shooting direction, set value of shooting device, or the like) or thumbnail image information (e.g., image data for thumbnail images, context information extracted from the thumbnail images, or the like) included in the additional information.

In various embodiments, the image processing module may generate the output image based on the updated additional information in response to detection of the update of the additional information.

In various embodiments, the image processing module may display the output image on a display that is functionally connected to the electronic device.

In various embodiments, an electronic device (e.g., the electronic device 101) for processing a plurality of images may include a memory for storing an image, and an image processing module (e.g., the image processing module 140) that is functionally connected to the memory.

In various embodiments, the image processing module may generate edge information of the image based on the filtered image.

In various embodiments, the image processing module may generate scale information of the image based on the scaled image.

In various embodiments, the image processing module may generate additional information related to the image using at least some of the edge information or the scale information.

In various embodiments, the image processing module may filter the image by passing the image through a Gaussian filter or a low-pass filter, or up-scaling a down-scaled image.

In various embodiments, the image processing module may generate the edge information by subtracting a filtered image from an image input to the filtering.

In various embodiments, the image processing module may insert at least one of figures information, location information, things information, time information, event information, shooting environmental information or thumbnail image information related to the image, into the additional information.

In various embodiments, the image processing module may insert at least one of the edge information, the scale information or the additional information into metadata that is stored as a portion of the image, or stored separately from the image.

In various embodiments, the image processing module may transmit the metadata to an external device for the electronic device.

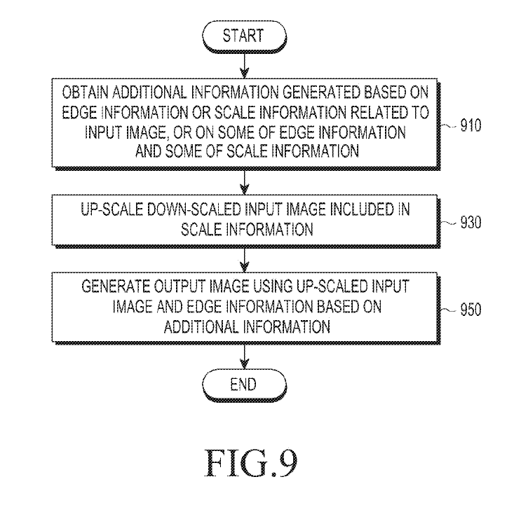

FIG. 9 is a flowchart illustrating a method for processing an image by an electronic device according to an embodiment of the present disclosure.

Referring to FIG. 9, in step 910, the electronic device (e.g., an image processing module thereof) obtains additional information generated based on edge information or scale information related to an input image, or on some of the edge information or some of the scale information. As described above, the electronic device may obtain additional information including at least one of binary data of the edge information or the scale information, high-frequency component information, color information, brightness information, pattern information, motion information or a black level value. The electronic device may obtain additional information including at least one of figures information, location information, things information, time information, event information, photographing environmental information or thumbnail image information related to the input image.

In step 930, the electronic device may up-scale a down-scaled input image included in the scale information. For example, the electronic device may up-scale the down-scaled input image using an up-scaler including an inverse function for the down-scaled input image based on the function.

In step 950, the electronic device may generate an output image using the up-scaled input image and the edge information, based on the additional information. As described above, the electronic device may generate the output image by up-scaling the down-scaled input image and summing up the up-scaled input image and the edge information using a summer. For example, the electronic device may generate the output image so that the output image may be substantially identical to the input image (e.g., without visual loss or data loss). The electronic device may generate the output image based on the updated additional information in response to a detection of the updated additional information.

In various embodiments, the image processing method may include obtaining additional information generated based on some of edge information or some of scale information related to an input image, and generating an output image corresponding to at least a portion of the input image based on the obtained additional information.

In various embodiments, the obtaining of the additional information may include obtaining the scale information and the edge information including an image down-scaled from the input image.

In various embodiments, the generating of the output image may include up-scaling the down-scaled image.

In various embodiments, the generating of the output image may include generating the output image further based on at least one of the up-scaled image or the edge information.

In various embodiments, the generating of the output image may include generating the output image so that the output image may be substantially identical to the input image (e.g., without visual loss or data loss).

In various embodiments, the generating of the output image may include generating the output image on which at least one image processing among anti-aliasing detail enhancement (AADA), edge enhancement or detail enhancement is performed for the input image, using high-frequency component information of the edge information included in the additional information.

In various embodiments, the generating of the output image may include generating the output image on which the brightness of at least a portion of the input image is changed, using the brightness information of the scale information included in the additional information.

In various embodiments, the generating of the output image may include associating the input image with at least one other image, based on at least one of figures information (e.g., name, phone number, Email address, home address, figures image, relationship with specific figures, or the like), location information (e.g., mountain, sea or the like), things information (e.g., flower, food or the like), time information (e.g., autumn, morning or the like), event information (e.g., wedding, birthday, trip to a particular area, or the like), sound information (e.g., surrounding sound during shooting), shooting environmental information (e.g., shooting location, shooting direction, set value of shooting device, or the like) or thumbnail image information (e.g., image data for thumbnail images, context information extracted from the thumbnail images, or the like) included in the additional information.

In various embodiments, the generating of the output image may include generating the output image based on the updated additional information in response to detection of the update of the additional information.

In various embodiments, the image processing method may further include displaying the output image on a display that is functionally connected to the electronic device.

In various embodiments, the image processing method may include generating edge information of the image based on filtering of the image, generating scale information of the image based on scaling of the image, and generating additional information related to the image using at least some of the edge information or the scale information.

In various embodiments, the generating of the edge information may include filtering the image by passing the image through a Gaussian filter or a low-pass filter, or up-scaling a down-scaled image.

In various embodiments, the generating of the edge information may include generating the edge information by subtracting a filtered image from an image input to the filtering.

In various embodiments, the generating of the additional information may include inserting, into the additional information, at least one of figures information (e.g., name, phone number, Email address, home address, figures image, relationship with specific figures, or the like), location information (e.g., mountain, sea or the like), things information (e.g., flower, food or the like), time information (e.g., autumn, morning or the like), event information (e.g., wedding, birthday, trip to a particular area, or the like), sound information (e.g., surrounding sound during shooting), shooting environmental information (e.g., shooting location, shooting direction, set value of shooting device, or the like) or thumbnail image information (e.g., image data for thumbnail images, context information extracted from the thumbnail images, or the like) related to the image.

In various embodiments, the image processing method may further include inserting at least one of the edge information, the scale information or the additional information into metadata that is stored as a portion of the image, or stored separately from the image.

In various embodiments, the image processing method may further include transmitting a metadata to an external device for the electronic device, as metadata that is stored as a portion of the image, or stored separately from the image.

At least a part of the apparatuses (e.g., modules or functions thereof) or method (e.g., operations) according to various embodiments of the present disclosure may be implemented by a command that is stored in computer-readable storage media (e.g., the memory 130) in the form of, for example, a program module. If the command is executed by one or more processors (e.g., the processor 120), the one or more processors may perform a function corresponding to the command.

The computer-readable storage media may include magnetic media (e.g., a hard disk, a floppy disk, and magnetic tape), optical media (e.g., a compact disc read only memory (CD-ROM) and a digital versatile disc (DVD)), magneto-optical media (e.g., a floptical disk), and a hardware device (e.g., a read only memory (ROM), a random access memory (RAM), or a flash memory). A program command may include a machine code such as a code made by a compiler, and a high-level language code that can be executed by the computer using an interpreter. The above-described hardware devices may be configured to operate as one or more software modules to perform the operations according to various embodiments of the present disclosure, and vice versa.

A module or a program module according to various embodiments of the present disclosure may include at least one of the above-described components, some of which may be omitted, or may further include additional other components. Operations performed by a module, a program module or other components according to various embodiments of the present disclosure may be performed in a sequential, parallel, iterative or heuristic way. Some operations may be performed in a different order or omitted, or other operations may be added.

As is apparent from the foregoing description, an apparatus and a method for processing images according to an embodiment of the present disclosure may process an image based on additional information, which is generated based on a portion of edge information or a portion of scale information related to the image. Accordingly, it is possible to efficiently process an image using a smaller amount of information that when using all of the edge information or all of the scale information.

An apparatus and a method for processing images according to an embodiment of the present disclosure may process an image using scale information of the image, and edge information into which remaining information, except for the scale information in the image, is inserted. Accordingly, it is possible to generate having substantially no visual loss or data loss, when compared with the original image.

An apparatus and a method for processing images according to an embodiment of the present disclosure may insert context information related to an image into additional information, and process the image based on the context information included in the additional information. Accordingly, it is possible to associate the image with other images including the same context information, and/or display the context information on the image in the form of text or graphic user interface.

While the present disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. An electronic device comprising:
a memory configured to store an image; and
an image processor configured to obtain additional information generated based on at least one of a portion of edge information and a portion of scale information related to an input image, and to generate an output image corresponding to at least a portion of the input image, based on the obtained additional information.

2. The electronic device of claim 1, wherein the image processor is further configured to up-scale the input image using the scale information, and to generate the output image from the up-scaled image, based on the obtained additional information.

3. The electronic device of claim 1, wherein the additional information is used in place of at least one of all of the scale information and all of the edge information, and
wherein the additional information is smaller in size than all of the edge information or all of the scale information.

4. The electronic device of claim 1, wherein the image processor is further configured to generate the output image being substantially identical to the input image.

5. The electronic device of claim 1, wherein the output image is visually lossless or data lossless with respect to the input image.

6. The electronic device of claim 1, wherein the additional information is generated based on the portion of the edge information or the portion of the scale information, when the input image is processed in an image pipeline for the input image, and
wherein the additional information includes at least one of binary data of the edge information or the scale information, high-frequency component information, color information, brightness information, pattern information, motion information, and a black level value.

7. The electronic device of claim 1, wherein the image processor is further configured to perform at least one of anti-aliasing detail enhancement (AADE), edge enhancement, and detail enhancement for generating the input image, using high-frequency component information included in the additional information.

8. The electronic device of claim 1, wherein the image processor is further configured to change brightness of the output image using brightness information included in the additional information.

9. The electronic device of claim 1, wherein the image processor is further configured to associate the input image with at least one other image, based on at least one of figures information, location information, things information, time information, event information, photographing environmental information, and thumbnail image information, included in the additional information.

10. The electronic device of claim 1, wherein the image processor is further configured to generate the output image based on updated additional information, in response a detection of the updated additional information.

11. An electronic device comprising:
a memory configured to store an image; and
an image processor configured to generate edge information of the image, based on filtering of the image, to generate scale information of the image, based on scaling of the image, and to generate additional information related to the image, based on at least one of a portion of the edge information and a portion of the scale information.

12. The electronic device of claim 11, wherein the image processor is further configured to generate the edge information having a high-frequency component by subtracting, from the image, a low-frequency component obtained by passing the image through a Gaussian filter or a low-pass filter.

13. The electronic device of claim 11, wherein the image processor is further configured to generate the edge information by subtracting a filtered image from the image before being filtered.

14. The electronic device of claim 11, wherein the image processor is further configured to insert at least one of the edge information, the scale information, and the additional information into metadata, and to transmit the at least one of the edge information, the scale information, and the additional information to an external device.

15. A method for processing an image by an electronic device, the method comprising:
obtaining additional information that is generated based on at least one of a portion of edge information and a portion of scale information related to an input image; and
generating an output image corresponding to at least a portion of the input image based on the obtained additional information.

16. The method of claim 15, wherein generating the output image comprises:
up-scaling the input image using the scale information; and
generating the output image by processing the up-scaled image based on the obtained additional information.

17. The method of claim 15, wherein generating the output image comprises generating the output image to be substantially identical to the input image.

18. The method of claim 15, wherein generating the output image comprises associating the input image with at least one other image, based on at least one of figures information, location information, things information, time information, event information, photographing environmental information, and thumbnail image information, included in the additional information.

19. The method of claim 15, wherein generating the output image comprises generating the output image based on updated additional information, in response to detecting the updated additional information.

20. The method of claim 15, generating the output image comprises changing brightness of the output image using brightness information included in the additional information.
